(19) United States
(12) Patent Application Publication
(10) Pub. No.: US 2023/0188802 A1
(43) Pub. Date: Jun. 15, 2023

(54) DELIVERY OF MEDIA CONTENT

(71) Applicant: BRITISH TELECOMMUNICATIONS PUBLIC LIMITED COMPANY, London (GB)

(72) Inventors: Brahim ALLAN, London (GB); Ian KEGEL, London (GB); Douglas WILLIAMS, London (GB)

(21) Appl. No.: 17/926,481

(22) PCT Filed: Apr. 27, 2021
(86) PCT No.: PCT/EP2021/060971

§ 371 Date: Nov. 18, 2022

(30) Foreign Application Priority Data
May 19, 2020 (GB) 2007389.6

(51) Int. Cl. H04N 21/6405; H04N 21/2187; H04N 21/84

(52) U.S. Cl. CPC H04N 21/6405; H04N 21/2187; H04N 21/84

(57) ABSTRACT

Methods and apparatus are disclosed for media content distribution. In one aspect, a computer-implemented method is disclosed comprising steps of: providing a plurality of media objects, including a default object, for selection by, unicast communication (27) to, and rendering by consumer entities (30a, 30b, 30c); receiving metadata (26) for a plurality of the consumer entities indicating an extent of use of at least a subset of the media objects by said consumer entities; applying a rule relating to the consumption of media objects by the consumer entities to the metadata; and responsive to the application of the rule, generating a composite of the default object and at least one other object for multicast communication (25) to at least a subset of the consumer entities.

### TECHNICAL FIELD

The present invention relates to the delivery of media content. In particular, the invention relates to the delivery of media content such as television content in the field of Object-Based Broadcasting (OBB).

### BACKGROUND

Traditionally, television and other such audio-visual media content has been delivered to viewers as a single composed video stream, with items such as a clean feed, channel logo, subtitles and audio all pre-combined and delivered in the single stream. Viewers are generally able to watch such content in the form in which it has been provided (while being able to use adjustments on their device for characteristics such as “volume”, “brightness”, etc.—these adjustments generally apply to the programme or other such content as a whole).

Object-Based Broadcasting (OBB) is a development in relation to the delivery of television and other such media content which allows the content of programmes to be customisable by and/or for each individual consumer (such as a viewer, listener or consumer) at their own consumer device. The “objects” relate to different (generally audio-visual, where the term can involve purely audio and purely visual) aspects that make up the media content and thus the overall television experience. Objects can be video (moving or still, involving images, graphics, text, etc.) and/or audio streams, and in the case of sports for example, might include individual camera feeds of crowds, players, managers, referees etc., and may also include items such as graphics overlays (e.g. sports statistics, leader-boards, etc.), alternative commentaries, background sound or other sounds, and other items.

By decomposing the media content into multiple and individually separate objects and providing these separately, the consumer can effectively act as their own director, selecting the combination of objects they wish to include in their instance of the programme and thereby determining their own viewing experience more than can be done simply with the controls and settings available when viewing a traditionally-broadcast television programme.

In object-based broadcasting content from a content source or distributor is provided to consumers and may be customisable by and/or for each individual consumer at their own consumer device. The customisations made by and/or for each individual consumer determine which content objects appear on their screen. The content objects may be rendered locally, on the individual consumer's device (or devices) or they may be rendered in the cloud and streamed to the individual consumer's device, or combinations of the above.

Referring to prior disclosures, a paper entitled “Object-Based Broadcasting—Curation Responsiveness and User Experience” by Armstrong, Brooks, Churnside, Evans, Melchior, and Shotton from the IBC Conference in Amsterdam in 2014, available online at: digital-library.theiet.org/content/conferences/10.1049/ib.2014.0038, discusses how the term ‘object-based media’ describes the representation of media content by a set of individual assets together with metadata describing their relationships and associations. At the point of consumption these objects can be assembled to create an overall user experience. The precise combination of objects can be flexible, and responsive to user, environmental and platform specific factors. Such an object-based approach can serve end users more effectively; by optimising the experience to best suit their access requirements, the characteristics of their playback platform or personal preferences. The paper presents an overview of the key characteristics and potential benefits of Object-Based Broadcasting and a case study of an object-based audio documentary, which can change duration in response to implicit or explicit input from a listener.

The “OBB 2-immerse project” has generated deliverables which go into some detail specifying how OBB architecture may work. In general these can be found online at . . . : 2immerse.eu/deliverables/

. . . of which the deliverable D2.4, entitled “Distributed Media Application Platform and Multi-Screen Experience Components: Description of Second Release” provides an illustrated tour of the project's technical achievements together with details of the status of the platform and components and key features, and of which part D4.1, entitled “Prototype Service Descriptions—Initial Version”, describes how various OBB experiences may appear.

An article on the BBC website authored by Joe Eyles entitled “A New View of the Weather: Forecaster5G, our Object-Based Weather Report”, dated 9 Sep. 2019, relates to a method of Dynamic Adaptive Streaming over IP Multicast (DASM) system. The method uses object-based broadcasting for weather forecasting in a mobile app. The app configures itself according to user device and user preferences through a server. The server broadcasts multiple objects through multicast for several devices and customises objects according to user needs through unicast.

Referring now to patent documents, United States patent application US2017/366590 (“Verizon/Kazerani et al”) relates to a multi-tenant over-the-top multicast system which integrates the per-user stream customisability of unicast with the large-scale streaming efficiencies of multicast.

U.S. Pat. No. 8,219,134 (“Quickplay Media/Maharajh et al”) relates to a technique for switching between broadcast and unicast content on a mobile device which involves making unicast and broadcast content available to the mobile device, and providing an application on the mobile device which allows for switching between the unicast and broadcast content.

### SUMMARY OF THE INVENTION

According to a first aspect of the invention, there is provided a computer-implemented method for media content distribution comprising:
providing a plurality of media objects, including a default object, for selection by, unicast communication to, and rendering by consumer entities;
receiving metadata for a plurality of the consumer entities indicating an extent of use of at least a subset of the media objects by said consumer entities;
applying a rule relating to the consumption of media objects by the consumer entities to the metadata; and
responsive to the application of the rule, generating a composite of the default object and at least one other object for multicast communication to at least a subset of the consumer entities.

While the selection of media objects may be performed just by respective consumer entities—responsive to input from a human user or based on the results of analysis by those consumer entities of the preferences of their respective human users, for example—some selection may be performed for or on behalf of the consumer entities prior to transmission of the media objects, at a server-side media content processing and distribution entity, for example. Such selection may be based on server-side analysis of the consumption of media objects by the respective consumer entities and/or by analysis of the consumption of media objects by other consumer entities.

Similarly, while the rendering of media objects may be performed just by respective consumer entities after communication of the media objects in question, some rendering may be performed for or on behalf of the consumer entities prior to or during transmission of the media objects, at a server-side media content processing and distribution entity or at a cloud-based intermediate entity, for example.

The order in which the selection, communication, and rendering of media objects is done may thus vary depending on whether some selection is performed prior to transmission and/or whether some rendering is performed before or during transmission.

According to preferred embodiments, the rule used may identify a metric for each media object of at least the subset of media objects corresponding to an extent of network resource involved in communicating the media object to consumer entities selecting the media object. The resource may be bandwidth, for example.

According to preferred embodiments, the rule may take account of one or more of the following, for example: the selection (or non-selection) of media objects by consumer entities; the frequency of selection of media objects by consumer entities; the extent of the selection; etc. The extent of the selection may reflect the duration for which media objects are selected and/or used by respective consumer entities, for example.

According to preferred embodiments, media object may include content suitable for rendering including one or more of: video; audio; static graphics; dynamic graphics; interactive graphics; text; virtual representations of content; composites of multiple other objects, etc.

According to preferred embodiments, the method may be performed in such a way as to reduce a resource consumption required for communication of the selected media objects to the at least a subset of the consumer entities. The resource may be bandwidth, for example.

According to preferred embodiments, the default media object may be provided to the consumer entities by multicast communication prior to the generation of the composite of the default media object and the at least one other media object.

According to preferred embodiments, the composite of the default media object and at least one other media object may be provided for multicast communication as an updated default media object.

According to preferred embodiments, the composite of the default media object and at least one other media object may be provided for multicast communication in one multicast stream to at least the subset of the consumer entities.

According to preferred embodiments, the composite of the default media object and at least one other media object may be provided for multicast communication in a plurality of multicast streams to at least the subset of the consumer entities.

According to preferred embodiments, the consumer entities are generally networked entities configured to receive streamed unicast and multicast communication of media objects. With preferred embodiments, the consumer entities are generally devices configured to combine and render media objects received via unicast and multicast communication. They may further be configured to output rendered media content and/or play rendered media content themselves.

According to a second aspect of the invention, there is provided apparatus for media content distribution comprising:
at least one interface configured to provide a plurality of media objects to consumer entities, the media objects including a default object, for selection by, unicast communication to, and rendering by said consumer entities; and
at least one interface configured to receive metadata for a plurality of the consumer entities indicating an extent of use of at least a subset of the media objects by said consumer entities;
a processor configured to apply a rule relating to the consumption of media objects by the consumer entities to the metadata; and responsive to the application of the rule, to generate a composite of the default object and at least one other object for multicast communication to at least a subset of the consumer entities.

According to a third aspect of the invention, there is provided a computer program element comprising computer program code to, when loaded into a computer system and executed thereon, cause the computer to perform the steps of a method according to the first aspect.

The various options and preferred embodiments referred to above in relation to the first aspect are also applicable in relation to the second aspect.

Preferred embodiments of the invention thus make use of a combination of multicast and unicast delivery systems to deliver media content to consumers consuming (i.e. watching/listening to) media content on networked audio-visual consumer devices that is based on an assembly of media objects. Multicast delivery may be employed for at least one default object (or default composite object) to reduce an overall cost of delivery, with a selection of popular objects being delivered to viewers by multicast. Less-popular objects may be delivered by unicast, possibly only to a few consumers who have specifically requested them or who are deemed to be likely to enjoy or benefit from them. The object(s) to be included in the multicast delivery are determined by analysing metadata indicative of which objects each consumer is actually watching/using/selecting (or indicative at least of which objects are actually being used/selected at each consumer device). Individual consumers are then able to augment their own media experience with further customisation adding any additional object(s) received via unicast.

Preferred embodiments of the invention may provide advantages in terms of efficiency (in terms of use of bandwidth, for example) while allowing consumers freedom to customise their own media experience, while also allowing for the complexity and amount of processing involved in rendering received content at user devices to be reduced, which is particularly important for mobile devices as fewer unique streams need to be processed by the rendering engine in the devices. This can improve reach and decrease battery consumption.

### BRIEF DESCRIPTION OF THE DRAWINGS

A preferred embodiment of the present invention will now be described with reference to the appended drawings, in which:

FIG. 1 is a block diagram of a computer system suitable for the operation of embodiments of the present invention or entities thereof;

FIG. 2 shows a system of entities which may be involved in media content distribution according to a preferred embodiment;

FIG. 3 shows modules which may be present in a consumer device to which media content is distributed;

FIGS. 4 and 5 illustrate two ways of implementing embodiments of the invention; and

FIG. 6 is a diagram illustrating alternatives ways in which multicast streams may be provided.

### DESCRIPTION OF PREFERRED EMBODIMENTS OF THE INVENTION

With reference to the accompanying figures, methods, apparatus and systems according to preferred embodiments will be described.

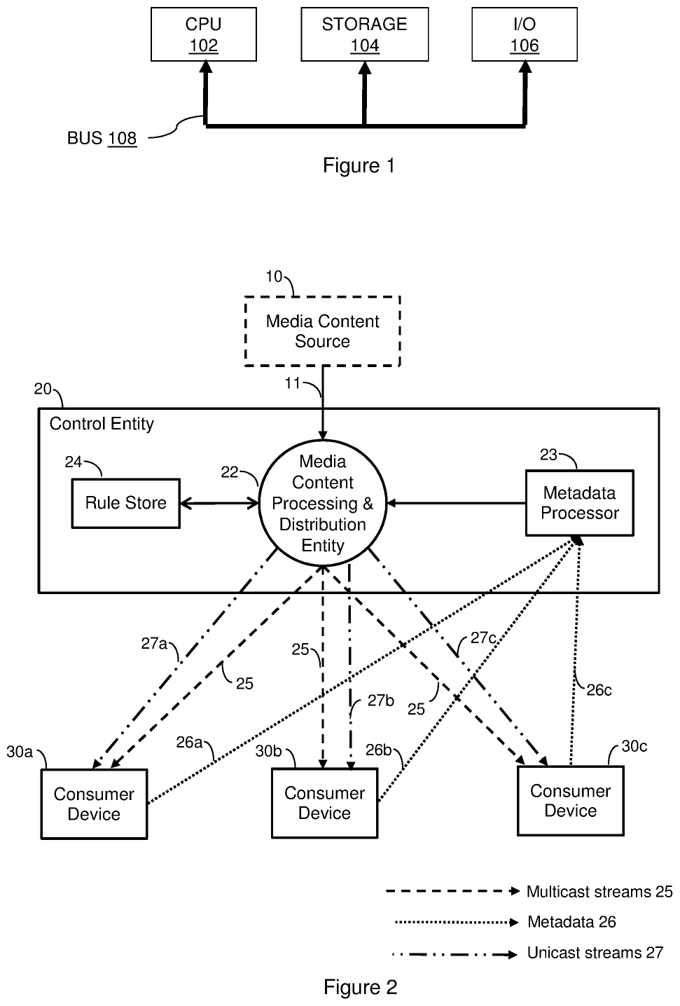

FIG. 1 is a block diagram of a computer system suitable for the operation of embodiments of the present invention or entities thereof. A central processor unit (CPU) 102 is communicatively connected to a data store 104 and an input/output (I/O) interface 106 via a data bus 108. The data store 104 can be any read/write storage device or combination of devices such as a random access memory (RAM) or a non-volatile storage device, and can be used for storing executable and/or non-executable data. Examples of non-volatile storage devices include disk or tape storage devices. The I/O interface 106 is an interface to devices for the input or output of data, or for both input and output of data. Examples of I/O devices connectable to I/O interface 106 include a keyboard, a mouse, a display (such as a monitor) and a network connection.

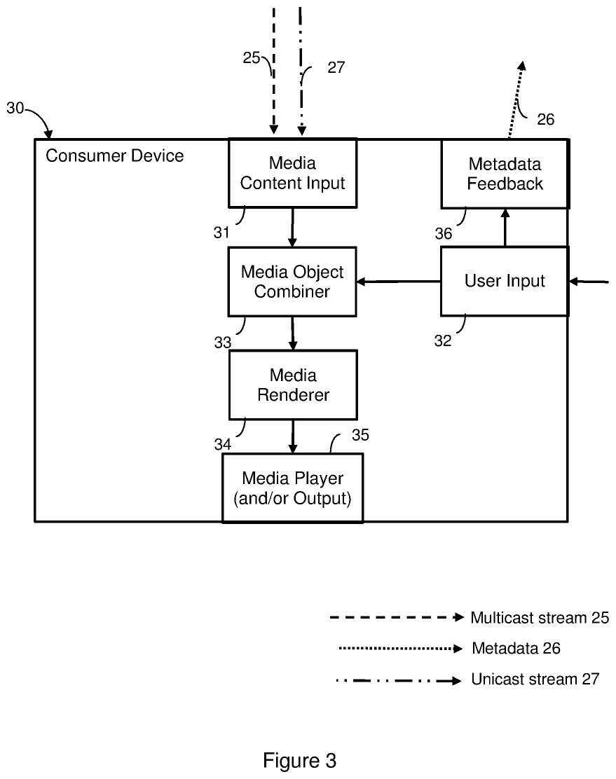

Referring now to FIG. 2, this shows a system of entities which may be involved in media content distribution according to a preferred embodiment, and in particular a control entity which may perform a method according to a preferred embodiment, together with other entities with which the control entity may interact.

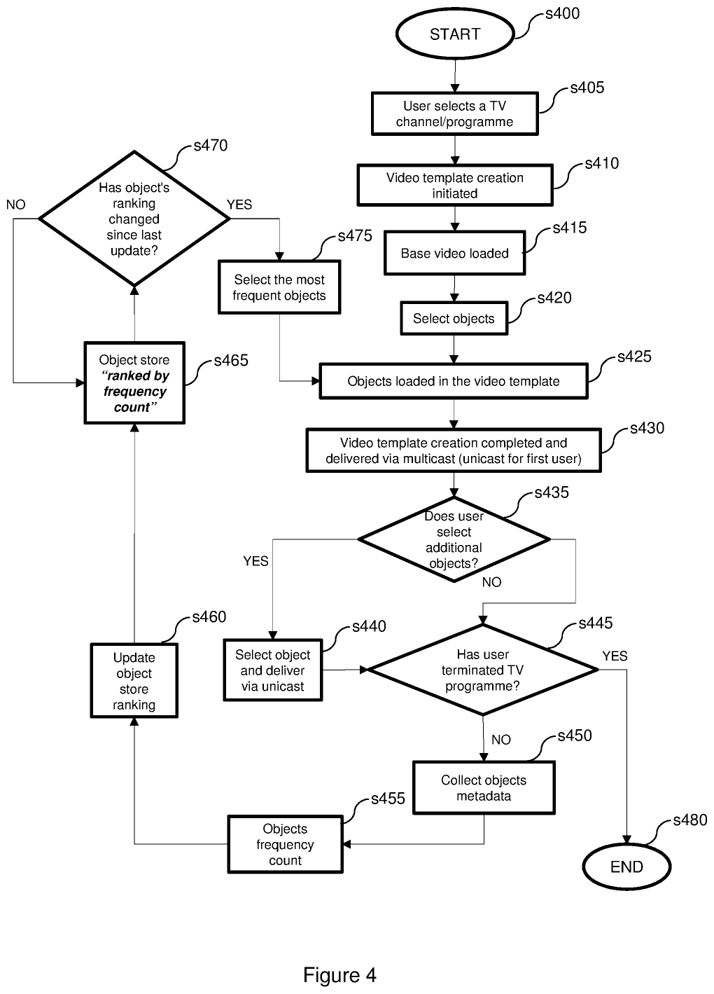

In this embodiment, a control entity 20 serves as a Digital Media Server (DMS), storing media content 11 which it may previously have received or may be receiving as a stream or otherwise from a separate media content source 10, and making the content available in the form of media objects to consumer devices 30a, 30b, 30c (generally 30) such as networked digital media players (DMPs) and/or digital media renderers (DMRs). As will be explained with reference to FIG. 3, the consumer devices 30 may perform the functions of rendering and playing received content, but these functions may be performed separately or by separate devices.

In this embodiment, the control entity 20 comprises a Media Content Processing and Distribution Entity (MCPDE) 22 from which the control entity 20 is able to provide a plurality of media objects for selection by, unicast communication to, and rendering by consumer devices 30. Consumer devices capable of playing rendered content may do so; others may be configured to provide such content to a separate media player, as applicable. The MCPDE 22 may be a stand-alone functional module, or may be combined with one or more other functional modules of the control entity 20 (discussed below).

The plurality of media objects provided to the consumer devices 30 includes a default object, which itself may be a default combination of media objects, or may be a single media object (e.g. a “base-video”, or an audio-visual “clean feed” with no additional or optional audio or visual objects). In the present embodiment, this is provided by multicast streaming (shown as dashed lines 25 to each of consumer devices 30a, 30b and 30c) (although in alternative embodiments, the default object may be provided at least initially via unicast streams to the respective consumer devices 30). Media objects not included as part of the default object (such as those in respect of additional or optional audio or visual objects) may be included alongside the default object in the multicast stream to the consumer devices 30 or may be selected individually by consumer devices (acting on the instructions of consumers) and provided to the respective consumer devices at least initially in the form of individual unicast streams (shown as dotted-dashed lines 27a, 27b, 27c (generally 27)).

In the present embodiment, the control entity 20 has a functional module referred to as a metadata processor 23 configured to receive feedback (possibly a dedicated input, or alternatively via a generic input or input/output interface, not shown in order to avoid unnecessary complexity) in the form of metadata (shown as dotted lines 26a, 26b, 26c (generally 26)) from the respective consumer devices 30a, 30b and 30c indicating an extent of use of at least a subset of the media objects by the respective consumer devices. The extent of use of a media object by a particular consumer device may be an indication of whether the media object in question is or isn't being selected and/or used by the particular consumer device, or may indicate how much the media object in question us being used by the particular consumer device, for example. Other measures of an extent of use of a media object by a consumer device will be apparent to those skilled in the art.

Having received such metadata, the control entity 20 applies a rule (which may be one of a plurality of rules stored in a rule store 24) relating to the consumption of media objects by the consumer devices to the metadata. This may be used to determine media objects which are being consumed by a plurality, by a comparatively large number, by a majority or by all of the consumer devices or by a subset thereof, and/or how much (in terms of, for example, temporal amount-of-use as well as number of devices, for example) the various media objects are being consumed by the consumer devices or by a subset thereof. As discussed below, the rule may also take account of “server-side” knowledge about the content being watched (i.e. available to the control entity 20 but not to the consumers, for example), predictions relating to the consumption of media objects by the consumer devices, the predictions being made based on knowledge of their past behaviour and/or the past behaviour of other consumers—those with similar viewing habits and/or preferences, for example.

The rule may involve partitioning consumer devices into subsets of the total population of consumer devices, the members of the subset being consumer devices identified as selecting/using the same or similar additional media objects for example, then treating one or more subsets of consumer devices as individual populations of consumer devices. This may be applicable where the total population of consumer devices is large enough to justify or benefit from such partitioning and/or where processing of the metadata indicates that such partitioning would be justifiable or beneficial. In such cases, a different multicast stream (and possibly a different unicast stream with additional objects not included in the multicast stream for the subset in question) may then be delivered to the members of the respective subsets.

As indicated above, the selection of media objects need not be driven just by metadata fed back from customer devices (based on user selection). For some types of programme or other such presentations, the timeline may be orchestrated based on a combination of pre-authored events and live input from a broadcaster, for example. Some media objects may only be available at certain times, while others may be forced to appear (or be prevented from appearing) at certain times, without user control. There could for example be a replay scheduled by a broadcaster which prevents the display of additional picture-in-picture streams for its duration. The metadata processor might therefore receive information such as ‘broadcaster production information’, possibly via a separate interface, with the rule allowing this information to be added to the metadata from the consumer devices, or at times, possibly even to over-rule what would be decided purely based on metadata fed back from customer devices.

As will be discussed below, different rules may be used to improve or optimise the delivery of media content in different ways, which may be (primarily) for the benefit of users, for the benefit of content providers, for the benefit of network services providers or for the benefit of others, or for the benefit of more than one type of entity.

Responsive to the application of the applicable rule, the control entity 20 generates a composite of the default object and at least one other object (which can constitute the creation of an updated default object) for multicast communication to at least a subset of the consumer devices (e.g. those that were previously selecting and/or using the additional media object or objects now added to the default object). The composite is then communicated by multicast streaming (dashed lines 25) to the consumer devices 30 or to the appropriate subset thereof for rendering (and, where applicable, viewing) by those consumer devices.

In an alternative to the above, instead of generating a composite of the default object and at least one other object (as an updated default object), the control entity 20 may—responsive to the application of an applicable rule—generate a composite stream including the default object and the at least one other object (without updating the default object itself) whereby to allow the composite stream with the respective objects to be delivered by multicast communication to at least a subset of the consumer devices (e.g. those that were previously selecting and/or using the additional media object or objects now added to the default stream). The composite is then communicated by multicast streaming (dashed lines 25) to the consumer devices 30 or to the appropriate subset thereof for rendering (and where applicable, viewing/playing) by those consumer devices.

In another alternative, the control entity 20 may—responsive to the application of an applicable rule—generate multiple streams each including one or more of the objects to be delivered by multicast communication to at least a subset of the consumer devices, rather than simply including these objects in a single multicast stream.

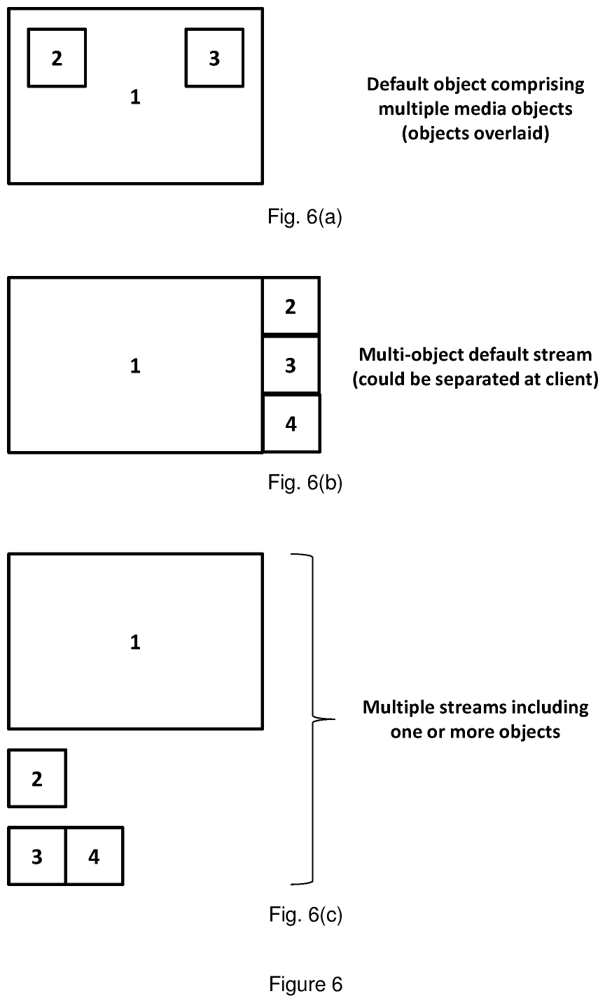

FIG. 6 is a diagram illustrating the alternatives discussed above as to how the multicast streams may be provided. In each case, each numbered box represents an indivisible media object (a video stream, for example) which may be provided by multicast. In FIG. 6(a), there is default media object 1 comprising multiple media objects, the other media objects 2, 3 being overlaid on the default object 1. In FIG. 6(b), there is again a default media object 1 in a multi-object default stream, but in this case the other media objects are not overlaid on media object 1. In this case, the media objects 1, 2, 3, 4 could easily be separated by client-side consumer devices 30 after multicast transmission. In FIG. 6(c), there is again a default media object 1, this time in one of a number of streams, and other media objects 2, 3, 4 in different streams (either with one media object per stream as with media object 2, or with more than one media object per stream as with media objects 3, 4). In this case, the media objects can easily be processed completely separately by client-side consumer devices 30 after multicast transmission.

Media objects not included as part of a composite object (such as the default object or as part of the updated multi-object default stream) but selected or deemed likely to be selected by particular consumer devices 30 may be included in individual unicast streams 27 to the consumer devices in question, at which they may be selected and/or used in combination with the default object as required (i.e. according to the wishes of a consumer).

Referring now to FIG. 3, this shows modules which may be present in consumer devices 30 such as those shown in FIG. 2, to which media content is distributed according to preferred embodiments.

Consumer devices 30 according to the present embodiment comprise a media content input 31 configured to receive a multicast stream 25 and a unicast stream 27 from the control entity 20, and to pass content received via both streams to a media object combiner 33 according to the requirements of a consumer entered via a user input 32 (or alternatively, determined or derived automatically on behalf of the consumer, on the basis of preferences, past behaviour, behaviour of others deemed to have similar preferences, or otherwise). The media object combiner module 33 acts to combine the default object and any additional media objects and pass the result to a media renderer module 34 which renders the chosen combination objects (the default object, potentially updated and received by multicast, and any additional objects selected by or for the consumer device, received by unicast) into a combined media content stream suitable for playing by a media player module 35 of the consumer device and/or provided as an output for playing by a separate media player (not shown).

Returning to the process performed by the control entity 20, there may be a single or default rule to be applied in respect of the metadata. Alternatively, there may be a plurality of different rules stored in the rule store 24, which may be used at different times or for different reasons. The rule may for example identify a metric for each media object (or of a subset of the media objects) corresponding to an extent of network resource involved in communicating the object to consumer entities selecting the object. Use of such a rule may be used to apportion objects between the multicast and unicast streams with a view to decreasing or minimising use of network resources (bandwidth, etc.), including objects selected/used by all or a significant proportion of the population (or of a population subset) in the multicast stream while only including other objects in unicast streams to particular consumer devices where appropriate.

The rule applied by the control entity 20 may take account of any or all of a variety of factors, such as the selection of objects by consumer devices 30; the frequency of selection of media objects by consumer devices; the extent of the selection (which may be the duration for which particular media objects are selected, or for which media objects selected by consumer devices are actually used in the eventual rendered content played by respective consumer devices, for example), “server-side” knowledge about the content being watched, broadcaster production information (as discussed earlier) or other factors, either explicitly selected by virtue of consumer devices as a result of consumer preferences input by consumers, or derived automatically on their behalf.

Using such a rule or otherwise, the method may be performed with a view to reducing resource consumption required for communication of the selected media objects to the consumer entities in question. Alternatively or additionally, the method may be performed with a view to improving user experience, by providing a combination of objects in the multicast feed that other users have found provide a good experience, for example.

The respective media objects may include content of a variety of types suitable for rendering at the consumer devices 30. They may include content such as video content; audio content; static graphics; dynamic graphics; interactive graphics; text; virtual representations of content; composites of multiple other objects, etc.

As indicated above, a predetermined default object may be provided to the consumer devices by multicast communication even prior to the receipt of feedback and to the generation of the composite of the default object and other objects. Alternatively, a default object for multicast streaming may initially be derived on the basis of metadata received in respect of media objects initially provided to consumer devices just be unicast streaming.

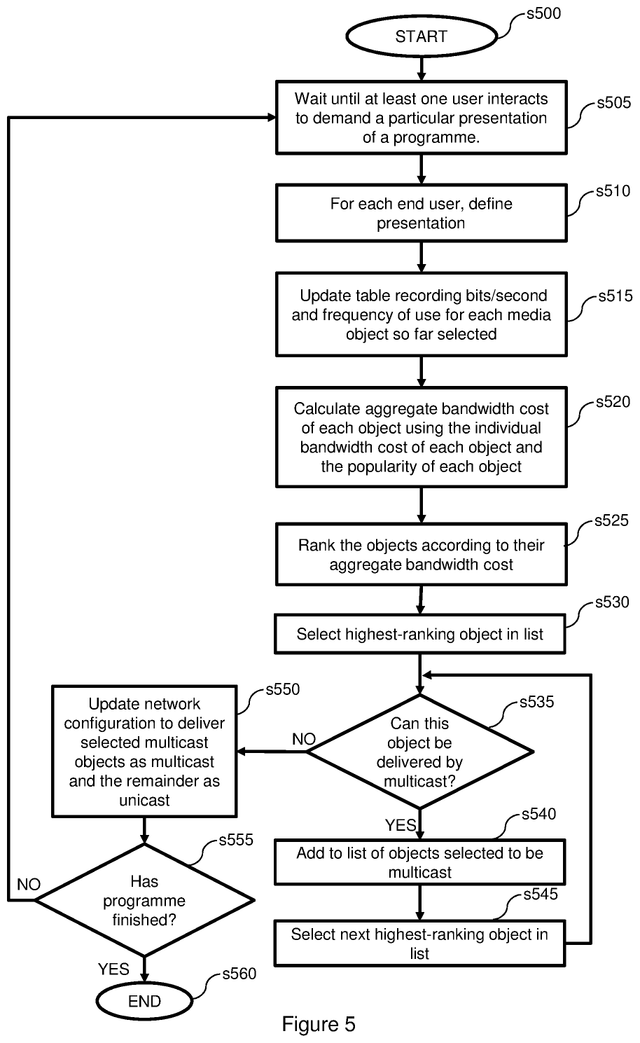

Referring now to FIG. 4 and FIG. 5, two different ways of implementing embodiments of the invention will be described.

FIG. 4 illustrates a method which may be used to improve the automatic selection as to which objects form part of a composite media template to be provided by multicast streaming and which are provided as possible additional objects by unicast streaming, which may serve to assist users in finding objects or combinations of objects which may improve their user experience while reducing a burden on consumer devices to combine and render an unnecessarily large number of separate objects.

As explained earlier, this embodiment makes use of knowledge obtained from use a combined multicast and unicast delivery system to deliver the objects most-used by users via multicast while allowing individual users to augment their viewing experience by selecting additional objects to be delivered via unicast.

Starting at step s400, a user selects (s405) a media source such as a channel and/or TV programme. At s410, creation of a media template is initiated. In the (initial) absence of feedback data, this may be based on past preferences or past data from previously-provided content, or based on creative considerations, pre-defined defaults or otherwise. At s415, a base media object is loaded. Other media objects may be selected (s420) and loaded (s425) into the media template to complete the creation of an initial media template for delivery, which would initially be delivered via unicast for the first user to select the media source, but as will become apparent, may subsequently be delivered via multicast (s430) once other users have selected the same media source. As will become apparent, some of the subsequent steps become applicable only once other users have selected the same media source (i.e. at step s405), and once the subsequent steps have been performed in respect of those other users as well as the first user.

Once other users have selected the same media source at step s405, steps s410 to s425 are performed in respect of each in order to create a media template. The subsequent steps shown in FIG. 4, described below, are then performed, resulting in a media template which may be delivered via multicast to at least a subset of the users who have selected the same media source. This may then be streamed by multicast to consumer devices for rendering and may thus serve as a default media stream that may, for example, be viewed in full screen (for video media) to at least a subset of the users who have selected the media source.

The next process is to start loading additional media objects from the object store, such that only top-ranked media objects according to ranking criteria (such as frequency count or another suitable rule relating to the consumption of media objects by consumers) are selected. As discussed earlier, media objects can include, for example, video and/or audio. In the exemplary case of a sports programme, media objects might be individual camera feeds of crowds, footballers, managers and referees, and/or could be overlay graphics with information such as sports statistics, etc.

The steps from s435 to s475 may be performed in respect of any user who has selected the same media source, and would generally be triggered by that user interacting with their device in order to select additional media objects.

At s435, the user in question has the chance to select additional media objects (i.e. objects that are not in the multicast stream) from the object store. If the user does not do so, the current situation may continue until the user terminates the programme (or stops watching the channel) in question (s445), after which the process ends (s480) for that user.

If the user does select additional media objects, these are delivered to the user in question by unicast (s440), this being in addition to the multicast stream with the base video and any additional objects included therein (which, once metadata feedback has been obtained, may reflect the most frequently-used objects by the population of users, or may otherwise reflect consumption of the media objects by the consumers).

If the user has not terminated (s445), metadata is collected (s450) in respect of the user and other users accessing the same media source, the metadata providing information about the media objects for each user and allowing a count of the frequency for each object (s455), as a result of which the object store ranking is updated (s460). It will be appreciated that the metadata may provide information about a number of metrics, e.g. frequency of occurrence, duration of use for each media object, etc., and that a rule may be applied to the metadata to update the object store ranking such as to take account of more than one.

Objects in the object store are ranked by frequency count (s465). The frequency-ranking of the objects in the object store may be intermittently or continuously checked (s470), and if any have changed, the multicast stream may be updated with the most frequently used objects.

To achieve this, the most frequent media objects are selected (s475) and the process returns to s425 at which stage they are loaded into the media template to be delivered via multicast. The process may continue in this manner until the user terminates (e.g. stops watching a channel) (s445), after which the process ends (s480).

FIG. 5 illustrates a method which may be used to improve the automatic selection as to which media objects of a media source (such as a TV programme or channel) are to be provided by multicast streaming and which may be provided as additional objects by unicast streaming. When users consume media content based on an assembly of media objects, a selection is made of the most popular or more popular objects to be delivered using multicast, with less-frequently used objects being delivered by unicast. This may be performed in a manner such that, as well as assisting users in finding objects or combinations of objects which may improve their user experience, the selection may serve to increase network transmission speed and/or efficiency and/or may serve to reduce bandwidth requirements and/or network cost.

Consider users choosing to watch a particular TV programme, for example. In an object-based broadcasting scenario, the system can decide, using rules and automated systems, the way that the programme is delivered to a target device or devices available to each user. This process includes a selection of a presentation for each user or device consisting of media objects rendered according to layout rules. This can happen for each user or device. For example, the system defines a presentation (for each user) that may be dependent upon a knowledge of each user's set-up and of their preferences.

When considering all consumers watching a programme, there may be many media objects that could be selected but there will be some objects that are much more likely to be selected than others.

According to the present embodiment, the system uses metadata related to each media object to identify a relative popularity across a relevant viewing audience of all the different media objects, seeking to reduce the overall bandwidth required to deliver relevant media content to relevant consumers. One way to reduce aggregate bandwidth is to deliver most popular content using multicast technology. While it is clear that such use of multicast may help, in an OBB scenario where respective end-users' viewed media may well be different, it is a challenge to determine which components should be multicast.

An optimising process can thus be used to determine which components should be multicast and which should be unicast, using knowledge derived from metadata related to the media objects that are being used. Once an optimised distribution solution has been calculated, a network component may then enact the recommendations preparing the different media objects, either as unique objects or as composite objects and prepare them as unicast and multicast streams as required.

Since the system will generally be dynamic, with users interacting with media rendered at their consumer device and thus effectively requesting new (adapted) media for rendering on an ongoing basis, the system can work on an ongoing basis to monitor an overall effectiveness in addressing the challenge of reducing overall use of bandwidth resource and/or other network costs/resources. To do so, the system can calculate network resource usage on an ongoing basis and assess whether a change to which objects are delivered using multicast and which are delivered by unicast.

Starting at step s500, a user uses one of their devices, this interaction resulting in particular media rendered at their consumer device such as a requested media source such as a TV programme, channel or the like (s505). This may happen for a number of users in respect of the same media source within a period of time such as that leading up to or just after the start of a live TV programme. At step s510, media for rendering at a consumer device is defined for each end user.

Steps s515 to s530 are performed in respect of the media objects selected by at least one user.

At step s515, a table recording the bits per second and frequency of use for each media object so far selected is updated.

At step s520, the aggregate bandwidth cost of each object is calculated using the individual bandwidth cost of each object and the popularity of each object.

At step s525, the objects are ranked according to their aggregate bandwidth cost.

At step s530, the object ranked highest according the aggregate bandwidth cost is selected.

At step s535, the system assesses whether it is possible to add the object selected in s530 to the list of objects that should be multicast.

If the assessment is that the object can be added to the multicast list (i.e. “yes”) then it is added to the multicast list in s540.

At step s545 the next highest ranked object (according to the list defined in s525) is selected and the process returns to s535 at which an assessment is made as to whether object can be added to the multicast list. If the assessment is “yes” then as before the object is added to the list of objects that should be multicast in s540.

If at s535 the assessment is made that the object cannot be added to the multicast list (i.e. “no”) (reasons for this may be related to cost, or the multicast bandwidth available to use, for example), then at step s550 the network configuration is updated so that the objects in the multicast list are delivered using multicast and the remaining objects are delivered using unicast.

At step s555 an assessment is made as to whether media from the media source has finished—e.g. the end of a TV programme. If the answer is “yes” then the process ends at step s560. If the assessment is “no” (e.g. that the programme has not finished), then the process returns to step s505 and waits for a user to interact and thus demand a particular presentation of media content.

Variations on this process may include alterations that control how frequently the unicast and multicast lists are updated at step s550. Controls could include:
Updating the network configuration at fixed intervals
Only updating when the change in cost is significant (above a threshold, for example)
Smoothing updates to avoid oscillation

A further variation may be to perform the calculation based on the assessment with respect to a range of different network topologies that may each have their own cost profiles leading to different results. The system may be tuned to deliver according to the service provider's needs, e.g. delivering lowest cost or highest performance or achieving specific service level parameters.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the invention may include other novel features or combinations of features disclosed herein. The applicant hereby gives notice that new claims may be formulated to such features or combinations of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1) A computer-implemented method for media content distribution comprising:
providing a plurality of media objects, including a default object, for selection by, unicast communication to, and rendering by consumer entities;
receiving metadata for a plurality of the consumer entities indicating an extent of use of at least a subset of the media objects by said consumer entities;
applying a rule relating to the consumption of media objects by the consumer entities to the metadata; and
responsive to the application of the rule, generating a composite of the default object and at least one other object for multicast communication to at least a subset of the consumer entities.

2) A method according to claim 1 wherein the rule identifies a metric for each media object of at least the subset of media objects corresponding to an extent of network resource involved in communicating the media object to consumer entities selecting the media object.

3) A method according to claim 1 wherein the rule includes: the selection of media objects by consumer entities; the frequency of selection of media objects by consumer entities; and/or the extent of the selection of media objects by consumer entities.

4) A method according to claim 1 wherein each media object includes content suitable for rendering including one or more of: video; audio; static graphics; dynamic graphics; interactive graphics; text; virtual representations of content; composites of multiple other media objects.

5) A method according to claim 1, the method being performed so as to reduce a resource consumption required for communication of the selected media objects to the at least a subset of the consumer entities.

6) A method according to claim 1 wherein the default object is provided to the consumer entities by multicast communication prior to the generation of the composite of the default media object and the at least one other media object.

7) A method according to claim 1 wherein the composite of the default media object and at least one other media object is provided for multicast communication as an updated default media object.

8) A method according to claim 1 wherein the composite of the default media object and at least one other media object is provided for multicast communication in one multicast stream to at least the subset of the consumer entities.

9) A method according to claim 1 wherein the composite of the default media object and at least one other media object is provided for multicast communication in a plurality of multicast streams to at least the subset of the consumer entities.

10) A method according to claim 1 wherein the consumer entities are networked devices configured to receive streamed unicast and multicast communication of media objects.

11) A method according to claim 1 wherein the consumer entities are configured to combine and render media objects received via unicast and multicast communication.

12) A method according to claim 10 wherein the consumer entities are further configured to output and/or play rendered media content.

13) Apparatus for media content distribution comprising:
at least one interface configured to provide a plurality of media objects to consumer entities, the media objects including a default object, for selection by, unicast communication to, and rendering by said consumer entities; and
at least one interface configured to receive metadata for a plurality of the consumer entities indicating an extent of use of at least a subset of the media objects by said consumer entities;
a processor configured to apply a rule relating to the consumption of media objects by the consumer entities to the metadata; and responsive to the application of the rule, to generate a composite of the default object and at least one other object for multicast communication to at least a subset of the consumer entities.

14) A computer program element comprising computer program code to, when loaded into a computer system and executed thereon, cause the computer to perform the steps of a method as claimed in claim 1.
